(19) United States
(12) Patent Application Publication
(10) Pub. No.: US 2016/0004799 A1
(43) Pub. Date: Jan. 7, 2016

(54) METHOD FOR GENERATING AN ELECTRIC INSTALLATION MODELLING FILE, COMPUTER PROGRAM PRODUCT, ASSOCIATED MODELLING FILE AND ELECTRONIC DISPLAY DEVICE

(71) Applicant: SCHNEIDER ELECTRIC INDUSTRIES SAS, Rueil-Malmaison (FR)

(72) Inventors: Carine GLAS, La Cote Saint Andre (FR); Christof BAEIJS, Seyssinet-Pariset (FR); Frederic BASTIN, Le Touvet (FR)

(73) Assignee: SCHEIDER ELECTRIC INDUSRIES SAS, Rueil-Malmaison (FR)

(21) Appl. No.: 14/768,028

(22) PCT Filed: Feb. 14, 2014
(86) PCT No.: PCT/EP14/52880

§ 371 Date: Aug. 14, 2015

(30) Foreign Application Priority Data
Feb. 15, 2013 (FR) 1351338

(51) Int. Cl. G06F 17/50

(52) U.S. Cl. CPC G06F 17/509

(57) ABSTRACT

A computer-implemented generation method, which can generate a computer file for modeling electrical equipment on the basis of a wiring diagram of the equipment. The generation method includes: determining, for each apparatus, a parent apparatus and one or more child apparatuses by tracking the diagram from a source to loads; determining, for each of electrical connections, a parent element and a child element, by tracking the diagram from the source to the loads; and creating a modeling file including a first identifier of the parent apparatus of each apparatus, a second identifier of the child device of each device, a third identifier of the parent element of each connection, and a fourth identifier of the child element of each connection.

The present invention relates to a method for generating a computer modeling file for an electric installation from an electric diagram of said electric installation, the method being implemented by a computer.

The electric installation includes at least one distribution panel including electric apparatuses able to be connected between a source and at least one electric load, and electric connections between the apparatuses, the electric diagram being in the form of a graph oriented according to the direction of flow of an electric current able to flow from the source towards the load(s).

The invention also relates to a computer program product including software instructions which, when they are implemented by a computer, implements such a method.

The invention also relates to such a computer modeling file for the electric installation.

The invention further relates to an electronic device for displaying information, intended to display information contained in such a modeling file. The electronic device is intended to be mounted in an electric distribution panel including at least one rail for mounting electric apparatuses, the electronic device including a display screen, means for displaying data on the screen and means for attachment to a corresponding rail.

From document EP 2 312 696 A1, an electronic display device of the aforementioned type is known. The electronic display device is intended to be mounted in an electric distribution panel including several rails for mounting electric apparatuses. The display device comprises two mounting modules each being provided with means for hooking up to the corresponding rail and a receptacle pivotally mounted with respect to the mounting modules in order to allow access to electric apparatuses mounted on the rail between the mounting modules.

The receptacle includes a display screen allowing display of information relating to the operation of the electric apparatuses mounted on the rail, notably by means of RFID communication means when the electric apparatuses are provided with a RFID radio-identification label.

However, the mechanical and electric assembly of the electric apparatuses in such an electric distribution panel is a relatively complex and tedious operation and the pieces of information displayed on the display screen of such a device are relatively limited and essentially concern the electric apparatuses provided with an RFID radio-identification label.

The object of the invention is therefore to propose an electronic device for displaying information giving the possibility of facilitating the mechanical and electric assembly of electric apparatuses in an electric distribution panel, and also proposing a computer file for modeling an electric installation including such a distribution panel, the modeling file containing information intended to be displayed by the display device, and a method for generating such a modeling file.

For this purpose, the subject-matter of the invention is a method for generating a computer file for modeling an electric installation from an electric diagram of said electric installation, the method being implemented by computer, the electric installation including at least one distribution panel including electric apparatuses able to be connected between a source and at least one electric load, and electric connections between the apparatuses, the electric diagram being in the form of a graph oriented along the direction of flow of an electric current able to flow from the source to the load(s).

The generation method comprises the following steps:
determining, for each electric apparatus, a parent apparatus and one or several child apparatus(es), by tracking the electric diagram from the sources to the load(s), the parent apparatus being directly connected to the electric apparatus and upstream from said apparatus along the direction of the current flow, the child apparatus(es) being directly connected to the electric apparatus and downstream from said apparatus along the direction of the current flow;
determining, for each electric connection, a parent element and a child element, by tracking the electric diagram from the source to the load(s), the parent element being an electric apparatus or an electric node laid out upstream from the connection along the direction of the current flow and to which said connection is connected, and the child element being an electric apparatus or an electric node laid out downstream from the connection along the direction of the current flow and to which said connection is connected; and
generating the computer modeling file, the modeling file including a first identifier of the parent apparatus of each electric apparatus, a second identifier of the child apparatus(es) of each electric apparatus, a third identifier of the parent element of each electric connection and a fourth identifier of the child element of each electric connection.

According to other advantageous aspects of the invention, the generation method comprises one or more of the following features, taken individually or according to all the technically possible combinations:
the method further comprises:
   calculating from a mechanical diagram of the electric installation and for each electric apparatus, positioning information of said apparatus in the electric installation, and
   adding into the computer modeling file generated previously, the positioning information of each electric apparatus;
said or each electric distribution panel includes at least one area, said or each area including at least one row, the electric apparatus being positioned in a given row of a given area of a given distribution panel, and the positioning information of each electric apparatus includes a first piece of identification information of said distribution panel, a second piece of identification information of said area, a third piece of identification information of said row and a fourth piece of information on the location of the apparatus in said row;
each electric connection includes at least one electric conductor, and the method further comprises:
   calculating, for each electric connection connecting a parent element to a corresponding child element, the number of electric conductors forming said connection and upstream and downstream connection points, the upstream connection point(s) connecting the conductor(s) to the corresponding parent element, and the downstream connection point(s) connecting the conductor(s) to the corresponding child element; and
   adding, in the computer modeling file generated previously and for each electric connection, the number of electric conductors and the upstream and downstream connection points.

The subject-matter of the invention is also a computer program product including software instructions which when they are implemented by a computer, applies the method as defined above.

The subject-matter of the invention is also a computer file, such as an XML file, for modeling an electric installation, the electric installation including at least one electric distribution panel including electric apparatuses able to be connected between a source and at least one electric load, and electric connections between the apparatuses, an electric current being able to flow along a direction of flow from the source to the load(s), the computer file comprising:
for each electric apparatus, a first identifier of a parent apparatus of said electric apparatus and a second identifier of one or several child apparatuses of said electric apparatus, the parent apparatus being directly connected to the electric apparatus and upstream from said apparatus along the direction of the current flow, and the child apparatus(es) being directly connected to the electric apparatus and downstream from said apparatus along the direction of the current flow;
for each electric connection, a third identifier of a parent element of said electric connection and a fourth identifier of a child element of said electric connection, the parent element being an electric apparatus or an electric node laid out upstream from the connection along the direction of the current flow and to which said connection is connected, and the child element being an electric apparatus or an electric node laid out downstream from the connection along the direction of the current flow and to which said connection is connected.

According to other advantageous aspects of the invention, the computer modeling file comprises one or several of the following features, taken individually or according to all the technically possible combinations:
the computer modeling file further comprises, for each electric apparatus, positioning information of said apparatus in the electric installation; and
said or each electric distribution panel includes at least one area, said or each area including at least one row, the electric apparatus being positioned in a given row of a given area of a given distribution panel, and the positioning information of each electric apparatus includes a first piece of identification information of said distribution panel, a second piece of identification information of said area, a third piece of identification information of said row and a fourth piece of information on the location of the apparatus in said row.

The subject-matter of the invention is also an electronic device for displaying information, intended to display pieces of information contained in a computer modeling file as defined above, the electronic device being intended to be mounted in an electric distribution panel including at least one rail for mounting electric apparatuses, the electronic device including a display screen, means for displaying data on the screen, and means for attachment to a corresponding rail, in which the electronic device further includes a unit for changing the display mode, and in that the unit for changing mode is able to allow the display of a first display mode indicating information relating to the mechanical mounting of the electric apparatuses on the rail and a second display mode indicating information relating to the electric cabling of the electrical apparatuses.

According to other advantageous aspects of the invention, the electronic display device includes one or more of the following characteristics, taken individually or in any technically possible combination:
the unit for changing mode is able to allow the display of a third mode indicating for each electric apparatus mounted on the rail, a pictogram depending on the type of electric load connected to said apparatus;
the device further includes a protective casing surrounding the display screen, the protective casing being preferably substantially rectangular and the unit for changing mode may be actuated manually and laid out on an outer face of the protective casing;
the device further includes a communication port, such as a USB port or an Ethernet port, for receiving the computer modeling file;
the device further includes means for reading a data storage memory, such as a reprogrammable and non-volatile memory, preferably an electrically erasable memory and which may be programmed by the user, still preferably a flash memory; and
the device further includes radioelectric communication means able to receive the computer modeling file from an external communicating device, such as a mobile phone.

These features and advantages of the invention will become apparent upon reading the description which follows, only given as a non-limiting example, and made with reference to the appended drawings, wherein:

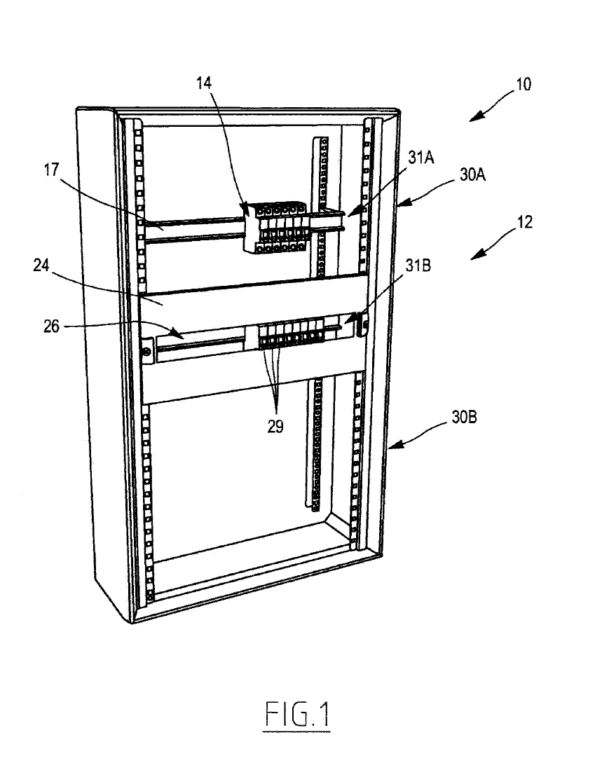

FIG. 1 is an overview of an electric installation including an electric distribution panel, the distribution panel including several electric apparatuses and rails for mounting electric apparatuses,

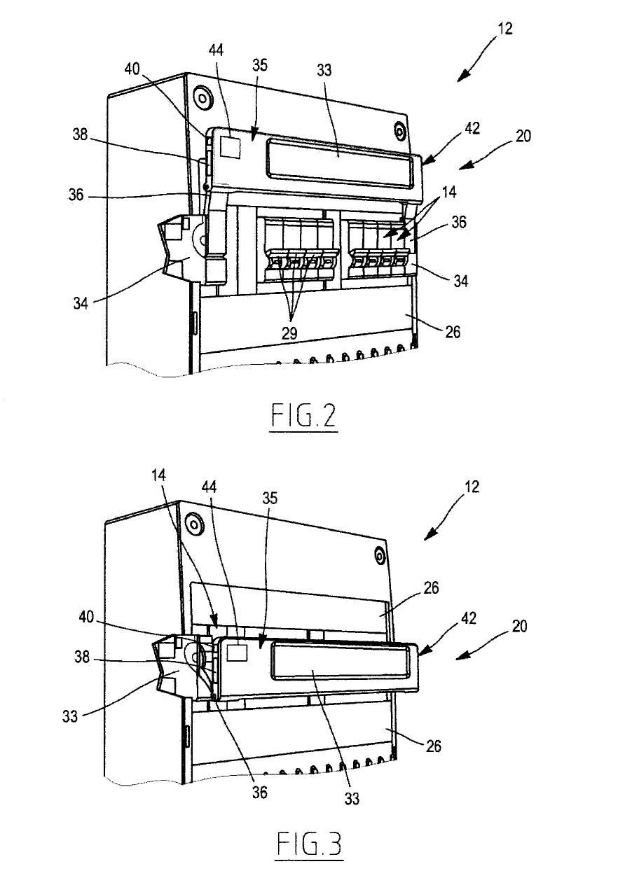

FIG. 2 is a partial and perspective view of electric apparatuses of FIG. 1 mounted on a rail and of an electronic device for displaying information, the display device being mounted on the rail and laid out according to a first configuration allowing access to the electric apparatuses, the display device including a display screen,

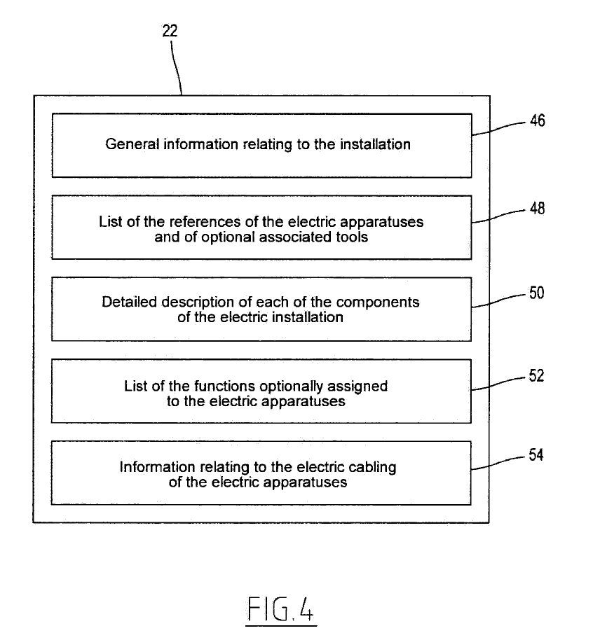

FIG. 3 is a view similar to that of FIG. 2, the display device being laid out according to a second configuration in which the display device hides the electric apparatuses with which it is associated,

FIG. 4 is a schematic illustration of a computer modeling file of the electric installation of FIG. 1,

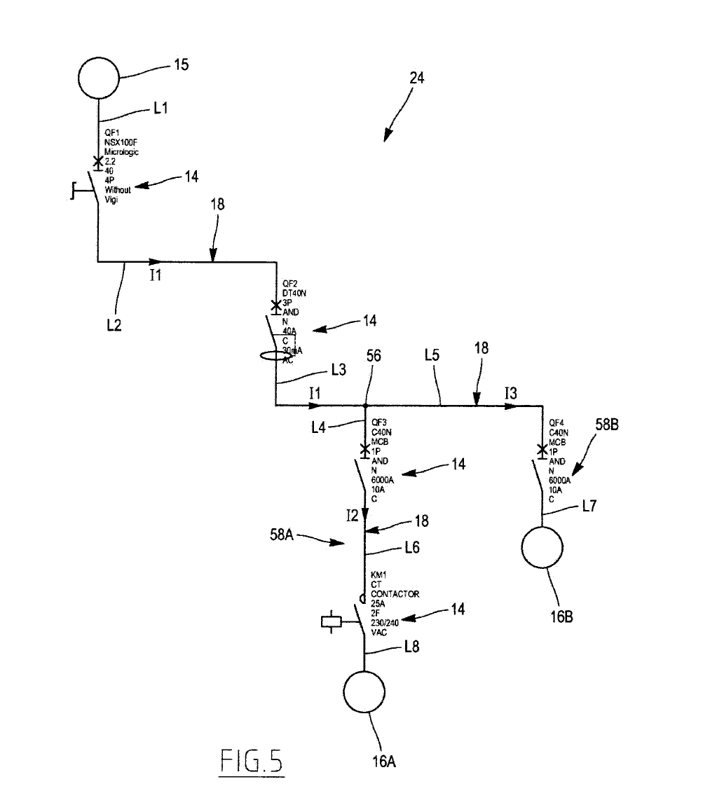

FIG. 5 is an electric diagram of a given electric distribution panel,

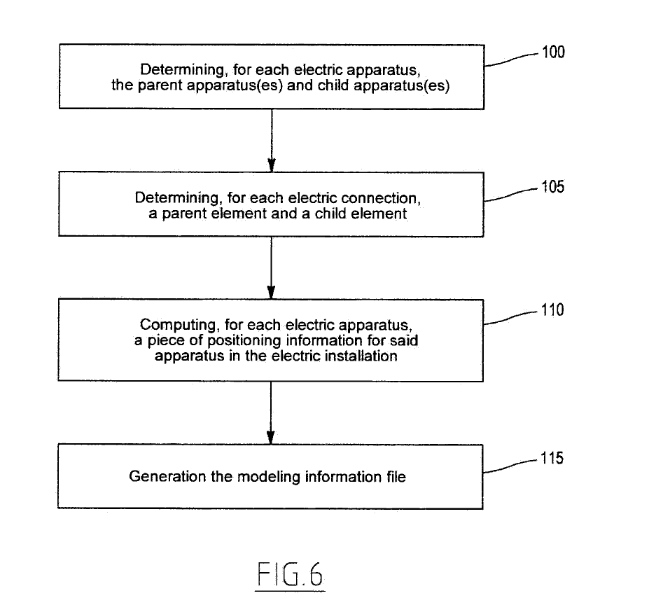

FIG. 6 is a flow chart of a method for generating the computer modeling file of FIG. 4,

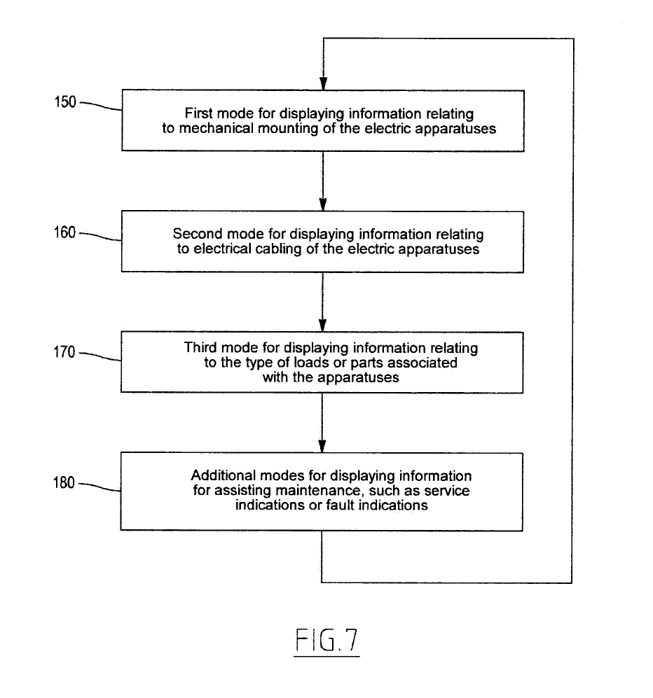

FIG. 7 is a flow chart of a method for displaying information according to different display modes during the mechanical and electric assembling of the distribution panel of FIGS. 2 and 3,

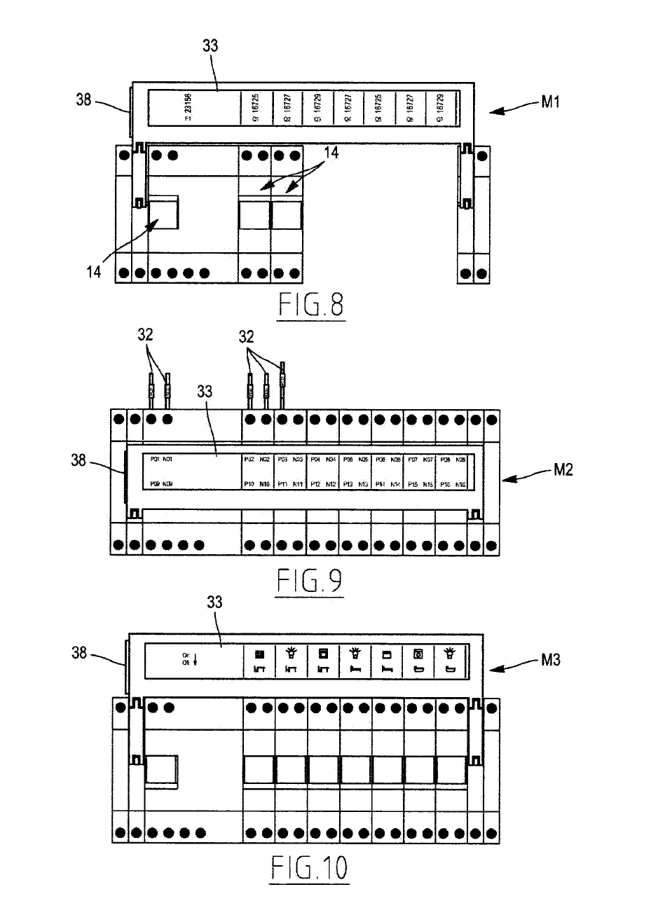

FIGS. 8 to 10 are schematic illustrations of the electronic display device and of the associated electric apparatuses according to different configurations of the display device and according to different display modes, and

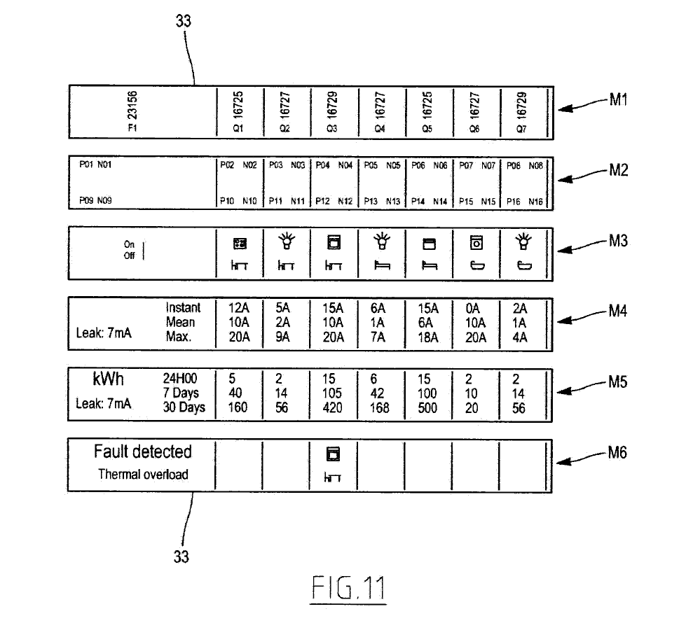

FIG. 11 illustrates various views of the display screen of the electronic display device according to the different display modes.

In FIG. 1, an electric installation 10 comprises an electric distribution panel 12, the distribution panel 12 including electric apparatuses 14 intended to be connected between a source 15 and at least one electric load 16A, 16B (FIG. 5), and rails 17 for mounting the electric apparatuses 14, such as DIN rails.

The electric installation 10 comprises electric connections 18, visible in FIG. 5, allowing connection of the electric apparatuses 14 with each other, an electric current being able to flow along a direction of flow from the source 15 to the load(s) 16A, 16B.

The electric installation 10 also comprises an electronic device 20 for displaying information, the display device 20, visible in FIGS. 2 and 3, being notably intended for displaying information contained in a computer modeling file 22, visible in FIG. 4.

The electric installation 10 may be illustrated from an electric point of view by means of an electric diagram 24, as illustrated as an example in FIG. 5.

The distribution panel 12 also includes a protective face plate 26 against the risks of electrocution, the protective face plate 26 being intended to limit the risk of manual contact with exposed electric conductors 32 and having a recess 28 for letting through the control levers 29 of the electric apparatuses 14.

The distribution panel 12 includes at least one area 30A, 30B, said or each area 30A, 30B including at least one row 31A, 31B associated with a respective rail 17, the electric apparatus 14 being positioned in a given row of a given area of a given distribution panel. In the example of FIG. 1, the distribution panel 12 includes two areas, i.e. an upper area 30A and a lower area 30B, and the upper area 30A includes two rows, i.e. a first upper row 31A and a second upper row 31B.

The electric apparatuses 14 are known per se, and for example are circuit breakers, differential circuit breakers, disconnecting devices, or further any other device intended to be mounted in an electric distribution panel.

Each electric connection 18 includes several electric conductors 32, visible in FIG. 9, the number of electric conductors 32 depending on the nature of the current, i.e. an alternating current or else a DC current, and on the number of phases of the current when this is an alternating current.

In FIGS. 2 and 3, the electronic display device 20 includes a display screen 33, means, not shown, for displaying data on the screen and two mounting modules 34, each being provided with means, not shown, for attachment to a corresponding rail 17.

The electronic display device 20 includes a protective casing 35 surrounding the display screen 33, the protective casing 35, also called a receptacle, preferably being substantially rectangular.

The electronic display device 20 also includes two jointing arms 36 of the receptacle 35 with respect to the mounting modules 34 between a first configuration, visible in FIG. 2, allowing access to the electric apparatuses 14, notably to their control levers 29, and a second configuration, visible in FIG. 3, in which the receptacle 35 hides the control levers 29 of the electric apparatuses 14 with which the electronic display device 20 is associated.

The electronic display device 20 further includes a unit 38 for changing the display mode, the unit for changing mode 38 being able to allow display of a first display mode (FIG. 8) indicating information relating to the mechanical mounting of the electric apparatuses 14 on the rail 17 and a second display mode (FIG. 9) indicating information relating to the electric cabling of the electric apparatuses 14. The mode changing unit 38 is additionally able to allow the display of a third mode (FIG. 10) indicating, for each electric apparatus 14 mounted on the rail 17, a pictogram depending on the type of electric load 16A, 16B connected to said apparatus 14. The mode changing unit 38 is for example in the form of a button which may be manually actuated and laid out on an outer face of the receptacle 35, as illustrated in FIGS. 2 and 3.

Additionally, the electronic display device 20 includes a communication port 40, visible in FIGS. 2 and 3, such as a USB (Universal Serial Bus) port or an Ethernet port, for receiving the computer modeling file 22 via a suitable communication link, such as a USB link, or further an Ethernet link.

Additionally, the electronic display device 20 includes means 42 for reading a data storage memory, such as a reprogrammable and non-volatile memory, preferably an electrically erasable memory and which may be programmed by the user, still preferably a flash memory.

Still additionally, the electronic display device 20 includes radioelectric communication means 44 able to receive the computer modeling file 22 from an external communicating device, such as a mobile phone, not shown, via a radioelectric data link.

The computer modeling file 22 is for example an XML file (Extensible Markup Language). Alternatively, the computer modeling file 22 is represented by a relational data model in a database.

The computer modeling file 22, visible in FIG. 4, includes a first portion 46 containing general information relating to the electric installation 10, this general information for example including the postal address of the location of the electric installation 10 and the coordinates of the operator provided for the mechanical and electric assembly of said electric installation 10.

The computer modeling file 22 includes a second portion 48 containing a list of references of the electric apparatuses 14 and of possible tools associated with said electric apparatuses 14, this list for example comprising, for each electric apparatus 14, a reference and a commercial name of said apparatus, and mounting and/or operating tools associated with this electric apparatus 14.

The computer modeling file 22 includes a third portion 50 containing a detailed description of each of the constituents of the electric installation 10, such as the electric apparatuses 14. This detailed description notably includes for each electric apparatus 14, positioning information of said apparatus in the electric installation 10.

The positioning information of each electric apparatus 14 includes a first identification information W of said distribution panel 12, a second piece of identification information X of the area 30A, 30B, a third piece of identification information Y of the row or the vertical position 31A, 31B and a fourth piece of information Z of the location of the apparatus 14 in said row 31A, 31B. The positioning information of each electric apparatus 14 is then for example written as W-X-Y-Z.

The computer modeling file 22 includes a fourth portion 52 containing a list of functions or uses possibly assigned to the electric apparatuses 14, a given use for example being the type of an electric load 16A, 16B connected to the corresponding electric apparatus 14, or further a room of a dwelling equipped with said electric installation 10, the room being associated with the corresponding electric apparatus 14.

The computer modeling file 22 includes a fifth portion 54 containing information relating to the electric cabling of the electric apparatuses 14. The information relating to the electric cabling comprises for each electric apparatus 14, a first identifier of parent apparatus(es) of said electric apparatus 14 and a second identifier of child apparatus(es) of said electric apparatus 14, the parent apparatus(es) being directly connected to the electric apparatus 14 and upstream from said apparatus 14 along the direction of the current flow from the source 15 to the load 16A, 16B, and the child apparatus(es) being directly connected to the electric apparatus 14 and downstream from said apparatus 14 along the direction of the current flow. The information relating to the electric cabling also comprises for each electric connection 18, a third identifier of a parent element of said electric connection 18 and a fourth identifier of a child element of said electric connection 18, the parent element being an electric apparatus 14 or an electric node 56 laid out upstream from the connection 18 along the direction of the current flow and to which said connection 18 is connected, and the child element being an electric apparatus 14 or an electric node 56 laid out downstream from the connection 18 along the direction of the current flow and to which said connection 18 is connected.

The modeling file 22 allows organization of the information in the form of unit entities and links between these entities, each entity unit being marked by a beginning and an end, for example by beginning and end markers within the scope of a file of the XML type. Semantics are associated with each of the entities and with each of the links, in order to explain the relevant entities and links, and to facilitate their interpretation.

The electric diagram 24 represents the electric installation 10 from an electric point of view, i.e. the different electric apparatuses 14 connected between the source 15 and electric loads 16A, 16B via the electric connections 18.

The electric diagram 24 is in the form of an oriented graph along the direction of flow of an electric current I1, I2, I3 able to flow from the source 15 to the load(s) 16A, 16B.

In the example of FIG. 5, the electric diagram 24 represents a first electric apparatus 14, noted as QF1, directly connected downstream from the source 15 via a first electric connection 18, noted as L1, and a second apparatus 14, noted as QF2, directly connected downstream from the first apparatus QF1 via a second electric connection 18, noted as L2. The second apparatus QF2 is connected downstream to a third apparatus 14, noted as QF3, on the one hand, via third and fourth electric connections 18, noted as L3 and L4, the third connection L3 being laid out between the second apparatus QF2 and a corresponding electric node 56 and the fourth connection L4 being laid out between the node 56 and the third apparatus QF3. The second apparatus QF2 is connected downstream to a fourth electric apparatus 14, noted as QF4 on the other hand, via the third connection L3 and a fifth electric connection 18, noted as L5, the fifth connection L5 being laid out between the node 56 and the fourth apparatus QF4. The third apparatus QF3 belongs to a first branch 58A laid out between the electric node 56 and a first load 16A, and the fourth apparatus QF4 belongs to a second branch 58B laid out between the electric node 56 and a second load 16B. The electric diagram 24 also represents a fifth electric apparatus 14, noted as KM1, connected downstream from the third apparatus QF3 via a sixth electric connection 18, noted as L6, the first electric load 16A being directly connected downstream from the fifth apparatus KM1 via a seventh electric connection 18, noted as L7. The fourth apparatus QF4 is connected directly downstream to the second electric load 16B via an eighth electric connection 18, noted as L8.

The method for generating the computer modeling file according to the invention will now be described by means of FIG. 6. The generation method is implemented by a computer including an information processing unit for example formed with a processor and a memory associated with the processor, not shown. The memory is able to store a piece of software for generating the modeling file.

During an initial step 100, the generation software package determines, for each electric apparatus 14, a parent apparatus and one or several child apparatuses, by scanning the electric diagram 24 from the source 15 to the load(s) 16A, 16B, the parent apparatus being directly connected to the electric apparatus 14 and upstream from said apparatus 14 according to the direction of the current flow, and the child apparatus(es) being connected directly to the electric apparatus 14 and downstream from said apparatus 14 along the direction of the current flow.

In the example of FIG. 5, the parent apparatus of the first apparatus QF1 is then conventionally the source 15, even if this is not an electric apparatus 14, strictly speaking, and the child apparatus of the first apparatus QF1 is the second apparatus QF2. Similarly, the parent apparatus of the second apparatus QF2 is the first apparatus QF1 and the child apparatuses of the second apparatus QF2 are the third apparatus QF3 and the fourth apparatus QF4. The parent apparatus of the fifth apparatus KM1 is the third apparatus QF3 and the child apparatus of the fifth apparatus KM1 is the first load 16A conventionally, even if this is not an electric apparatus 14 strictly speaking. In a similar way, the parent apparatus of the fourth apparatus QF4 is the third apparatus QF3 and the child apparatus of the fourth apparatus QF4 is the second load 16B.

The generation software package then determines, during a step 105 and for each electric connection 18, a parent element and a child element, by scanning the electric diagram 24 from the source 15 to the load(s) 16A, 16B, the parent element being an electric apparatus 14 or an electric node 56 laid out upstream from the connection 18 along the direction of the current flow and to which said connection 18 is connected, and the child element being an electric apparatus 14 or an electric node 56 laid out downstream from the connection 18 along the direction of the current flow and to which said connection 18 is connected.

In the example of FIG. 5, the parent element of the first connection L1 is then the source 15 conventionally, even if this is not an electric apparatus 14 or a node 56 strictly speaking, and the child element of the first connection L1 is the first apparatus QF1. The parent element of the second connection L2 is the first apparatus QF1, and the child element of the second connection L2 is the second apparatus QF2. The parent element of the third connection L3 is the second apparatus QF2, and the child element of the third connection L3 is the node 56, and so forth. The parent element of the seventh connection L7 is the fourth apparatus QF4, and the child element is the second load 16B conventionally, even if this is not an electric apparatus 14 or a node 56 strictly speaking. Finally, the parent element of the eighth connection L8 is the fifth apparatus KM1, and the child element of this eighth connection L8 is the first load 16A conventionally.

Additionally, during this step 105, the generation software package calculates, for each electric connection 18 connecting a parent element to a corresponding child element, the number of electric conductors 32 forming said connection 18 and the upstream and downstream connection points, the upstream connection point(s) connecting the conductor(s) 32 to the corresponding parent element, and the downstream connection point(s) connecting the conductor(s) 32 to the corresponding child element.

Additionally, during the following step 110, the generation software package calculates, from a mechanical diagram of the electric installation 10 and for each electric apparatus 14, positioning information of said apparatus 14 in the electric installation 10.

The positioning information of each electric apparatus 14 is then for example written as W-X-Y-Z as described earlier, wherein W is the first piece of identification information of said table 12, X is the second piece of identification information of the area 30A, 30B, Y is the third piece of identification information of the row 31A, 31B and Z is the location number of the apparatus 14 in said row 31A, 31B.

The generation software package finally generates, during step 115, the computer modeling file 22, the modeling file 22 including the first identifier of the parent apparatus of each electric apparatus 14, the second identifier of the child apparatus(es) of each electric apparatus 14, the third identifier of the parent element of each electric connection 18 and the fourth identifier of the child element of each electric connection 18.

The modeling file 22 further comprises additionally the number of electric conductors 32 and the upstream and downstream connection points of each electric connection 18.

The modeling file 22 further comprises additionally the positioning information W-X-Y-Z of each electric apparatus 14.

Additionally, the modeling file 22 comprises pieces of information, not shown, describing a project associated with the electric installation 10. The pieces of description information of the project for example include the name and the address of a corporation concerned by the project, and/or the name and the coordinates of a reference person for this project.

Still additionally, the modeling file 22 includes commercial information, not shown, associated with the electric installation 10. The pieces of commercial information for example include the commercial name of each of the electric apparatuses 14 included in the electric installation 10, the price of these electric apparatuses 14 as well as optionally other commercial information associated with these electric apparatuses 14.

The modeling file 22 thus groups the information relating to four different domains, i.e. the electrical domain, the mechanical domain, the domain for describing the project and the commercial domain. The electric domain notably includes information associated with the electric components 14 and with the electric connections 18, such as the first identifier of the parent apparatus of each electric apparatus 14, the second identifier of the child apparatus(es) of each electric apparatus 14, the third identifier of the parent element of each electric connection 18 and the fourth identifier of the child element of each electric connection 18. The mechanical domain notably includes pieces of positioning information W-X-Y-Z of each electric apparatus 14. The domain for describing the project includes description information on the project as described earlier, and the commercial domain includes the aforementioned pieces of commercial information. The modeling file 22 is then a pivot element between these four domains.

FIG. 7 illustrates a flow chart of a method for displaying information according to different display modes during the mechanical and electric assembling of the distribution panel 12, these different display modes giving the possibility of facilitating the assembling operations by limiting consultation of annexed documentation, or even by avoiding consultation of such documentation.

During an initial step 150, the electronic device 20 applies a first display mode M1 indicating, for each electric apparatus 14 to be mounted on the rail 17 to which the device 20 is attached, a reference and the positioning of said apparatus 14, as illustrated in FIG. 8. In the example of FIG. 8, electric apparatuses 14 each having the reference 16725 for example have to be fixed in the locations Q1 and Q5 of the corresponding row to said rail 17. Electric apparatuses 14 each having the reference 16727 have to be fixed at the locations Q2, Q4 and Q6. The operator then knows, and without needing to consult another document, at which location the different apparatuses 14 are to be exactly fixed, the references of which are generally recalled on the body of the apparatus.

At the end of step 150, when the operator has positioned all the electric apparatuses 14 in the corresponding row 31A, 31B, he/she presses on the display mode changing unit 38 in order to switch from the first display mode M1 to a second display mode M2.

During the next step 160, the second display mode M2 indicates, for each electric apparatus 14, the numbers of electric conductors 32 to be connected to said apparatus 14, as illustrated in FIG. 9. As an example, in FIG. 9, the operator has to connect the electric conductors 32 numbered as P01 and N01 upstream from the electric apparatus 14 located on the far left of the row, as well as the electric conductors 32 numbered as P09 and N09 downstream from this apparatus 14 on the far left. The operator thus knows which electric conductors 32 he/she has to connect upstream and downstream from this electric apparatus 14 of the row, each electric conductor 32 bearing a ring with the single identification number displayed by the display device 20 in this second mode M2.

At the end of step 160, when the operator has electrically cabled all the electric apparatuses 14 in the corresponding row 31A, 31B, he/she presses on the unit for changing display mode 38 before switching from the second display mode M2 to a third display mode M3.

The third display mode M3 allows, during the next step 170, the display, for each electric apparatus 14 mounted on the rail 17, of indications relating to the type of electric load 16A, 16B connected to said apparatus 14 or further to a room of a housing in which the electric installation 10 is laid out. These indications of the third display mode M3 are for example displayed as pictograms, as illustrated in FIG. 10.

In the example of FIG. 10, the electric apparatuses have the following functions starting from the left most apparatus of the row and moving towards the right: a general differential circuit breaker for the left most apparatus 14, and then a circuit breaker associated with cooking hobs in the kitchen, a circuit breaker associated with a light in the kitchen, a circuit breaker associated with an electric oven in the kitchen, a circuit breaker associated with a light in a room, a circuit breaker associated with electric outlets in the room, a circuit breaker associated with a washing machine in a bathroom and a circuit breaker associated with a light in the bathroom. It is thus possible for a same electric apparatus 14 to display both an indication relative to the type of load associated with the apparatus 14 and an indication relative to the associated room of the dwelling.

At the end of step 170, when the operator has checked that all the electric apparatuses 14 actually corresponded to the functions displayed by the display device 20 in the third mode M3, he/she if need be presses on the unit for changing display mode 38 in order to switch from the third display mode M3 to additional and successive display modes M4, M5, M6, visible in FIG. 11. These additional modes for displaying information M4, M5, M6 provide assistance with maintenance, the displayed information containing in these additional modes service indications such as consumed current intensities or consumed powers, or further defect indications. The display device 20 displays in a fourth display mode M4 pieces of information relating to the instantaneous, average and maximum current consumptions for each of the electric apparatuses 14. The display device 20 displays in a fifth display mode M5 pieces of information relating to the consumed powers during the last 24 hours, the last 7 days or further during the last 30 days. In a sixth display mode M6, the display device 20 displays one or several defect indications for one or several given electric apparatuses 14, as illustrated in FIG. 11.

The display device 20 according to the invention then also facilitates maintenance of the electric installation 10.

It is thus conceivable that the electronic display device 20 according to the invention gives the possibility of facilitating the mechanical and electric assembling of the electric apparatuses 14 in the electronic distribution panel 12, by displaying the information required for the operator during gradual assembling of the distribution panel 12, notably by means of the mode changing unit 38 giving the possibility of easily passing from one display mode to another.

It is also conceivable that the computer modeling file 22 of the electric installation gives the possibility of facilitating the mechanical and electric assembling of the electric apparatuses 14, by grouping the information intended to be displayed by the display device 20.

Finally, the method for generating the modeling file also facilitates the work of the operator by automatically generating the modeling file 22 from the electric diagram 24 of the installation, or even additionally from a mechanical diagram of the electric installation 10.

1-14. (canceled)

15. A method for generating a computer modeling file of an electric installation from an electric diagram of the electric installation, the method being implemented by a computer, the electric installation including at least one distribution panel including electric apparatuses configured to be connected between a source and at least one electric load, and electric connections between the apparatuses, the electric diagram being in a form of a graph oriented along a direction of flow of an electric current able to circulate from the source to the load,
the method comprising:
determining, for each electric apparatus, a parent apparatus and one or plural child apparatuses, by scanning the electric diagram from the source to the load, the parent apparatus being directly connected to the electric apparatus and upstream from the electric apparatus according to the direction of the current flow, and each child apparatus being directly connected to the electric apparatus and downstream from the electric apparatus along the direction of the current flow;
determining, for each electric connection, a parent element and a child element, by scanning the electric diagram from the source to the load, the parent element being an electric apparatus or an electric node laid out upstream from the connection according to the direction of the current flow and to which the connection is connected, and the child element being an electric apparatus or an electric node laid out downstream from the connection according to the direction of the current flow and to which the connection is connected; and
generating the computer modeling file, the modeling file including a first identifier of the parent apparatus of each electric apparatus, a second identifier of each child apparatus of each electric apparatus, a third identifier of the parent element of each electric connection, and a fourth identifier of each child element of each electric connection.

16. The method according to claim 15, further comprising:
calculating, from a mechanical diagram of the electric installation and for each electric apparatus, a piece of positioning information of the apparatus in the electric installation; and
adding, in the computer modeling file generated earlier, the piece of positioning information of each electric apparatus.

17. The method according to claim 16, wherein each electric distribution panel includes at least one area, each area including at least one row, the electric apparatus being positioned in a given row of a given area of a given distribution panel, and wherein the piece of positioning information of each electric apparatus includes a first piece of identification information of a distribution panel, a second piece of identification information of the area, a third piece of identification information of the row, and a fourth piece of information of the location of the apparatus in the row.

18. The method according to claim 15, wherein each electric connection includes at least one electric conductor, and the method further comprising:
calculating, for each electric connection connecting a parent element to a corresponding child element, the number of electric conductors forming the connection and upstream and downstream connection points, the upstream connection point connecting the conductor to the corresponding parent element, and the downstream connection point connecting the conductor to the corresponding child element; and
adding, in the computer modeling file generated previously and for each electric connection, the number of electric conductors and the upstream and downstream connection points.

19. A non-transitory computer readable medium including a computer program product including software instructions which when they are implemented by computer implements the method according to claim 15.

20. A computer file for modeling an electric installation, the electric installation including at least one electric distribution panel including electric apparatuses configured to be connected between a source and at least one electric load, and electric connections between the apparatuses, an electric current being able to circulate along a direction of flow from the source to the loads,
the computer file comprising:
for each electric apparatus, a first identifier of a parent apparatus of the electric apparatus and a second identifier of one or plural child apparatuses of the electric apparatus, the parent apparatus being directly connected to the electric apparatus and upstream from the apparatus along the direction of the current flow, and the child apparatus being directly connected to the electric apparatus and downstream from the apparatus along the direction of the current flow;
for each electric connection, a third identifier of a parent element of the electric connection and a fourth identifier of a child element of the electric connection, the parent element being an electric apparatus or an electric node laid out upstream from the connection along the direction of the current flow and to which the connection is connected, and the child element being an electric apparatus or an electric node laid out downstream from the connection along the direction of the current flow and to which the connection is connected.

21. The computer file according to claim 20, wherein the computer modeling file further includes, for each electric apparatus, a piece of positioning information of the apparatus in the electric installation.

22. The computer file according to claim 21, wherein each electric distribution panel includes at least one area, each area including at least one row, the electric apparatus being positioned in a given row of a given area of a given distribution panel, and wherein the piece of positioning information of each electric apparatus includes a first piece of identification information of the distribution panel, a second piece of identification information of the area, a third piece of identification information of the row, and a fourth piece of information of the location of the apparatus in the row.

23. An electronic device for displaying information, configured to display information contained in a computer modeling file according to claim 20, the electronic device configured to be mounted in an electric distribution panel including at least one rail for mounting electric apparatuses, the electronic device comprising:
a display screen;
means for displaying data on the screen;
means for attachment to a corresponding rail;
a display mode changing unit for changing the display mode, and the display mode changing unit is configured to allow the display of a first display mode indicating information relating to the mechanical mounting of the electric apparatuses on the rail and a second display mode indicating information relating to the electric cabling of the electric apparatuses.

24. The device according to claim 23, wherein the display mode changing unit is configured to allow the display of a third mode indicating, for each electric apparatus mounted on the rail, a pictogram depending on a type of electric load connected to the apparatus.

25. The device according to claim 23, further comprising a protective casing surrounding the display screen, and the display mode changing unit is actuatable manually and laid out on an outer face of the protective casing.

26. The device according to claim 23, further comprising a communication port for receiving the computer modeling file.

27. The device according to claim 23, further comprising means for reading a data storage memory.

28. The device according to claim 23, further comprising radioelectric communication means configured to receive the computer modeling file from an external communicating device.
